(19) United States
(12) Patent Application Publication
(10) Pub. No.: US 2017/0077533 A1
(43) Pub. Date: Mar. 16, 2017

(54) CONTROL METHOD AND SYSTEM OF FUEL CELL SYSTEM

(71) Applicant: Hyundai Motor Company, Seoul (KR)

(72) Inventor: Hyun Jae Lee, Seoul (KR)

(21) Appl. No.: 15/155,396

(22) Filed: May 16, 2016

(30) Foreign Application Priority Data
Sep. 14, 2015 (KR) 10-2015-0129890

(51) Int. Cl. H01M 8/04303; H01M 8/04858; H01M 8/04537; H01M 8/04746; H01M 8/04111; H01M 8/04007; H01M 8/04992; H01M 8/04291; H01M 8/1004; H01M 8/1007; H01M 8/1018; H01M 8/241; H01M 8/2457; H01M 8/04228; H01M 8/04223; H01M 8/04492

(52) U.S. Cl. CPC H01M 8/04303; H01M 8/04507; H01M 8/04858; H01M 8/04544; H01M 8/04753; H01M 8/04111; H01M 8/04768; H01M 8/04007; H01M 8/04992; H01M 8/04291; H01M 8/1004; H01M 8/1007; H01M 8/1018; H01M 8/241; H01M 8/2457; H01M 8/04228; H01M 8/04231; H01M 2250/20; H01M 2008/1095; H01M 16/006

(57) ABSTRACT

A control method and system of a fuel cell system are provided. The control method includes measuring humidity of air in a fuel cell stack and temporarily stopping an electricity generation of a fuel cell mounted within a vehicle when the measured humidity is predefined humidity or less.

### CROSS-REFERENCE TO RELATED APPLICATION

This application is based on and claims the benefit of priority to Korean Patent Application No. 10-2015-0129890, filed on Sep. 14, 2015 in the Korean Intellectual Property Office, the disclosure of which is incorporated herein in its entirety by reference.

### TECHNICAL FIELD

The present disclosure relates to a control method and system of a fuel cell system, and more particularly, to a control method of a fuel cell system that adjusts humidity of a fuel cell stack using an idle stop control.

### BACKGROUND

A fuel cell stack is an electricity generation system that directly converts emitted energy in response to an oxidation reaction by oxidizing fuel by an electrochemical process into electric energy. The fuel cell stack has a membrane-electrode assembly formed by inserting a pair of electrodes made of a porous material into both sides of a polymer electrolyte membrane to selectively transport hydrogen ions to maintain both sides of the polymer electrolyte membrane. Each of the pair of electrodes includes a carbon powder supporting platinum based metal catalyst as a main component, and a catalyst layer that contacts the polymer electrolyte membrane, and a gas diffusion layer formed on a surface of the catalyst layer and simultaneously having breathability and electronic conductivity.

An idle stop indicates that an electricity generation of a fuel cell is stopped during the idle stop of a vehicle, and thus the idle stop is distinguished from a shutdown of the fuel cell generation when terminating the driving of the vehicle. However, a conventional idle stop has been limited to a purpose for improving fuel efficiency or improving system efficiency.

### SUMMARY

The present disclosure utilizes an electricity generation stopping function to optimize humidity of a fuel cell system. Additionally, the present disclosure improves humidity in a low current and low output section and to avoid a dry state of a fuel cell stack and improves a driving stability of a fuel cell and durability of the stack.

However, objects of the present disclosure are not limited to the objects described above, and other objects that are not described above may be clearly understood by those skilled in the art from the following description. According to an exemplary embodiment of the present disclosure, a control method of a fuel cell system may include measuring humidity of air in a fuel cell stack; and temporarily stopping an electricity generation of a fuel cell mounted within a vehicle when the measured humidity is predefined humidity or less.

According to another exemplary embodiment of the present disclosure, a control method of a fuel cell system may include temporarily stopping an electricity generation of a fuel cell mounted within a vehicle; re-measuring humidity of air in a fuel cell stack after performing temporarily stopping the electricity generation stopping; and resuming the electricity generation of the fuel cell when the re-measured humidity is predefined humidity or greater.

Specific matters of other exemplary embodiments will be included in a detailed description and the accompanying drawings.

### BRIEF DESCRIPTION OF THE DRAWINGS

The above and other objects, features and advantages of the present disclosure will be more apparent from the following detailed description taken in conjunction with the accompanying drawings.

FIG. 1 is a block diagram of a fuel cell system functioning as a power system of a fuel cell vehicle according to an exemplary embodiment of the present disclosure;

FIGS. 2 to 6 are flowcharts illustrating a control method of a fuel cell system according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referral to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Advantages and features of the present disclosure and methods to achieve them will be elucidated from exemplary embodiments described below in detail with reference to the accompanying drawings. However, the present disclosure is not limited to exemplary embodiments disclosed below, but will be implemented in various forms. The exemplary embodiments of the present disclosure make discussion of the present disclosure thorough and are provided so that those skilled in the art can easily understand the scope of the present disclosure. Therefore, the present disclosure will be defined by the scope of the appended claims. Like reference numerals throughout the description denote like elements.

Hereinafter, the present disclosure will be described with reference to the accompanying drawings for describing a control method of a fuel cell system according to exemplary embodiments of the present disclosure.

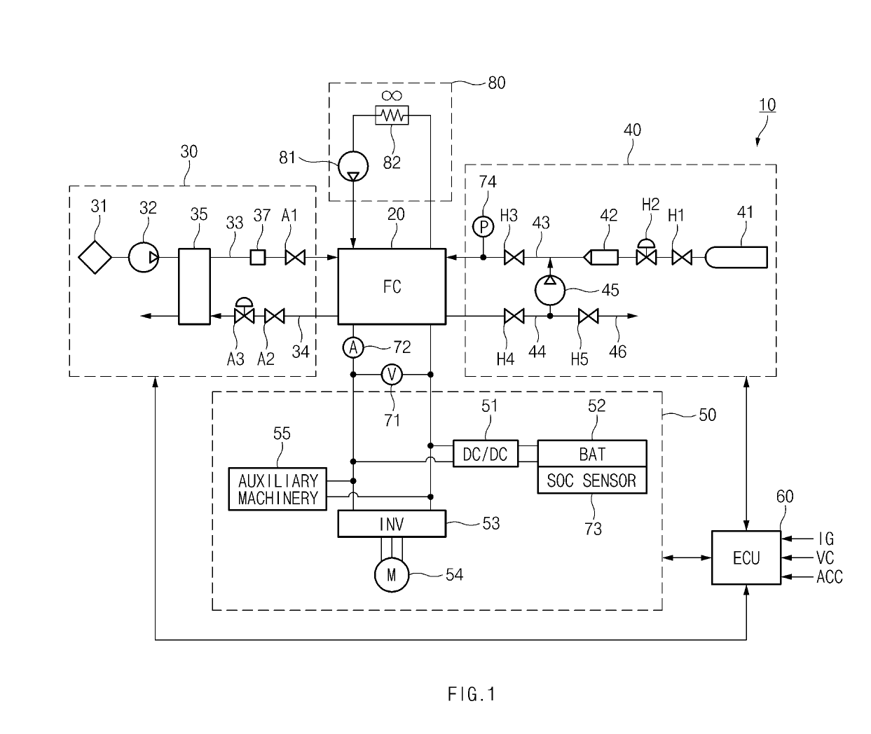

FIG. 1 is a block diagram of a fuel cell system 10 functioning as a power system of a fuel cell vehicle. The fuel cell system 10, which functions as the power system of the vehicle, may include a fuel cell stack 20 configured to receive reaction gas (e.g., fuel gas, oxide gas, or the like) and to generate electricity, an oxide gas supply system 30 configured to supply air as the oxide gas to the fuel cell stack 20, a fuel gas supply system 40 configured to supply hydrogen gas as fuel gas to the fuel cell stack 20, a wattmeter 50 configured to execute a charging and discharging of power, and a controller 60 configured to generally operate the whole system.

The fuel cell stack 20 is a solid polymer electrolyte type cell stack formed by stacking a plurality of cells in series with each other. In the fuel cell stack 20, an oxidation reaction according to Chemical formula (1) below occurs from an anode electrode, and a reduction reaction according to Chemical formula (2) below occurs a cathode electrode. As a whole of the fuel cell stack 20, an electricity generation reaction according to Chemical formula (3) below occurs.

H₂→2H++2e (1)

(½)O₂+2H++2e-→H₂O (2)

H₂+(½)O₂→H₂O (3)

The fuel cell stack 20 may include a voltage sensor 71 configured to detect an output voltage (e.g., an FC voltage) of the fuel cell stack 20, and a current sensor 72 configured to detect an output current (e.g., an FC current) thereof. The oxide gas supply system 30 may include an oxide gas flow passage 33 in which oxide gas supplied to the cathode electrode of the fuel cell stack 20 flows, and an oxide off gas flow passage 34 in which oxide off gas exhausted from the fuel cell stack 20 flows. The oxide gas flow passage 33 may include an air compressor 32 having a filter 31 disposed therein to receive the oxide gas from atmosphere, a humidifier 35 configured to humidify the oxide gas compressed by the air compressor 32, and a blocking valve A1 configured to block a supply of the oxide gas to the fuel cell stack 20.

Further, the oxide off gas flow passage 34 may include a blocking valve A2 configured to block an exhaust of oxide off gas from the fuel cell stack 20, a back pressure adjusting valve A3 configured to adjust oxide gas supply pressure, and a humidifier 15 configured to exchange humidity between the oxide gas (dry gas) and the oxide off gas (wet gas). The fuel gas supply system 40 may include a fuel gas supply source 41, a fuel gas flow passage 43 in which fuel gas supplied to the anode electrode of the fuel cell stack 20 from the fuel gas supply source 41 flows, a circulating flow passage 44 for feedbacking fuel off gas exhausted from the fuel cell stack 20 to the fuel gas flow passage 43, a circulating pump 45 configured to pressure-feed the fuel off gas in the circulating flow passage 44 to the fuel gas flow passage 43, and a purge flow passage 46 branch-connected to the circulating flow passage 44.

The fuel gas supply source 41 may include, for example, a high pressure hydrogen tank, a hydrogen absorbing alloy, or the like, and may be configured to store hydrogen gas of high pressure (e.g., about 35 MPa to 70 MPa). When a blocking valve H1 is opened, the fuel gas may be discharged from the fuel gas supply source 41 to the fuel gas flow passage 43. The fuel gas may be decompressed, for example, up to about 200 kPa by a regulator H2 or an injector 42 and may be supplied to the fuel cell stack 20.

In addition, the fuel gas supply source 41 may also include a reformer configured to generate reformed gas having rich hydrogen from hydrocarbon based fuel, and a high pressure gas tank configured to accumulate the reformed gas generated by the reformer into a high pressure state. The fuel gas flow passage 43 may include the blocking valve H1 configured to block or permit the supply of the fuel gas from the fuel gas supply source 41, the regulator H2 configured to adjust pressure of the fuel gas, the injector 42 configured to adjust a supply amount of fuel gas to the fuel cell stack 20, a blocking valve H3 configured to block the supply of the fuel gas to the fuel gas stack 20, and a pressure sensor 74.

The regulator H2 may be configured to adjust upstream pressure (e.g., primary pressure) thereof to preset secondary pressure, and may include, for example, a mechanical reducing pressure valve configured to reduce the primary pressure, and the like. The mechanical reducing pressure valve may have a box body in which a back pressure chamber and a pressure regulating chamber are formed while having a diaphragm therebetween, and the primary pressure in the pressure regulating chamber may be decompressed to predetermined pressure by the back pressure in the back pressure chamber to form the secondary pressure.

The circulating flow passage 44 may be connected to the blocking valve H4 configured to block the exhaust of the fuel off gas from the fuel cell stack 20, and the purge flow passage 46 branched from the circulating flow passage 44. The purge flow passage 46 may include a purge valve H5 operated by the controller 60 to discharge the fuel off gas containing impurities in the circulating flow passage 44 and moisture to the exterior.

By opening the purge valve H5, concentration of the impurities in the fuel off gas in the circulating flow passage 44 may be decreased, to thus increase concentration of hydrogen in the fuel off gas circulated in a circulating system. The purge valve H5 may be disposed to cause the discharged fuel off gas to be mixed with the oxide off gas flowing in the oxide off gas flow passage 34 and to be diluted by a diluter (not illustrated). The circulating pump 45 may be configured to circulate and supply the fuel off gas in the circulating system into the fuel cell stack 20 by a motor drive. The wattmeter 50 may include a direct current (DC)/DC converter 51, a battery 52, a traction inverter 53, a traction motor 54, and an auxiliary machinery 55.

Particularly, the fuel cell system 10 may be configured as a parallel hybrid system in which the DC/DC converter 51 and the traction inverter 53 are connected in parallel to the fuel cell stack 20. The DC/DC converter 51 may be configured to increase a direct current (DC) voltage supplied from the battery 52 and output the increased DC voltage to the traction inverter 53, and reduce DC power generated by the fuel cell stack 20 or regenerative power collected by the traction motor 54 by a regenerative braking to charge the battery 52.

A charging and discharging of the battery 52 may be executed by the DC/DC converter 51. Further, a driving point (e.g., an output voltage and an output current) of the fuel cell stack 20 may be adjusted by a voltage conversion control by the DC/DC converter 51. The battery 52 operates as a storage source of dump power, a storage source of regenerative energy during the regenerative braking, and an energy buffer during a load variation in response to acceleration or deceleration of a fuel cell vehicle.

As the battery 52, for example, a Ni—Cd storage battery, Ni-MH and lithium secondary battery, and the like may be used. The battery 52 may include a state of charge (SOC) sensor configured to detect a SOC of the battery. The traction inverter 53 may be, for example, a pulse width modulation (PWM) inverter driven in a PWM scheme, and may be configured to convert the DC voltage output from the fuel cell stack 20 or the battery 52 into a three-phase alternating current (AC) voltage based on a control instruction or signal from the controller 60 to adjust rotational torque of the traction motor 54. The traction motor 54 may be, for example, a three-phase AC motor, and may be a power source of the fuel cell vehicle.

The auxiliary machinery 55 collectively refers to the respective motors (e.g., power sources of pumps, or the like) disposed at the respective portions in the fuel cell system 10, inverters configured to drive the above-mentioned motors, and a variety of vehicle-mounted auxiliary machinery (e.g., the air compressor, the injector, a coolant circulating pump, the radiator, etc.). The controller 60, which may be a computer system including a central processing unit (CPU), a read only memory (ROM), a random access memory (RAM), and an input and output interface, may be configured to operate the respective portions of the fuel cell system 10.

For example, when the controller 60 receives a start signal IG output from an ignition switch, the controller 60 may be configured to start the driving of the fuel cell system 10, and calculate driving power of the vehicle or consumption power of the auxiliary machinery based on an accelerator opening degree (e.g., engagement degree or an amount of pressure exerted onto the accelerator pedal) signal ACC output from an accelerator sensor, or a vehicle speed signal VC output from a vehicle speed sensor. In addition, the controller 60 may be configured to adjust an electricity generation using an increased value of an electricity generation instruction value calculated from a summation value of the driving power of the vehicle and the consumption power of the auxiliary machinery, and an electricity generation instruction value calculated from a high potential avoiding voltage as an electricity generation instruction value for the fuel cell stack 20.

Particularly, the consumption power of the auxiliary machinery may include power consumed by the vehicle mounted auxiliary machinery (e.g., the humidifier, the air compressor, a hydrogen pump, the coolant circulating pump, etc.), power consumed by devices (e.g., a transmission, a wheel controller, a steering gear, a suspension system, etc.) necessary to drive the vehicle, power consumed by devices (e.g., an air conditioning device, a lighting fixture, an audio, etc.) installed within a passenger space, and the like.

In addition, the controller 60 may be configured to determine a distribution of output power of each of the fuel cell stack 20 and the battery 52, operate the oxide gas supply system 30 and the fuel gas supply system 40 to match an electricity generation amount of the fuel cell stack 20 to target power, and operate the DC/DC converter 51 simultaneously to adjust the output voltage of the fuel cell stack 20, to thus adjust the driving point (e.g., the output voltage and the output current) of the fuel cell stack 20. Further, the controller 60 may be configured to output each of AC voltage instruction values of an U phase, a V phase, and a W phase to the traction inverter 53, for example, as a switching instruction to obtain target torque based on the accelerator engagement degree, and adjust the output torque and the number of revolution of the traction motor 54. A cooling system 80 may include a coolant pump 81 configured to adjust a coolant, and a radiator 82 configured to remove heat of the coolant.

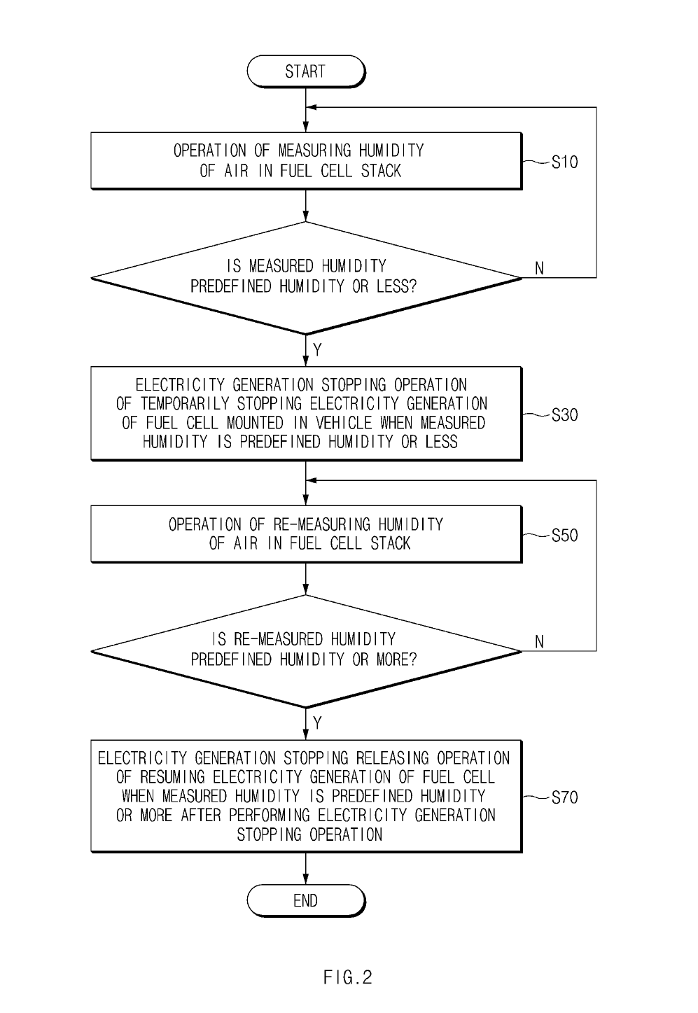

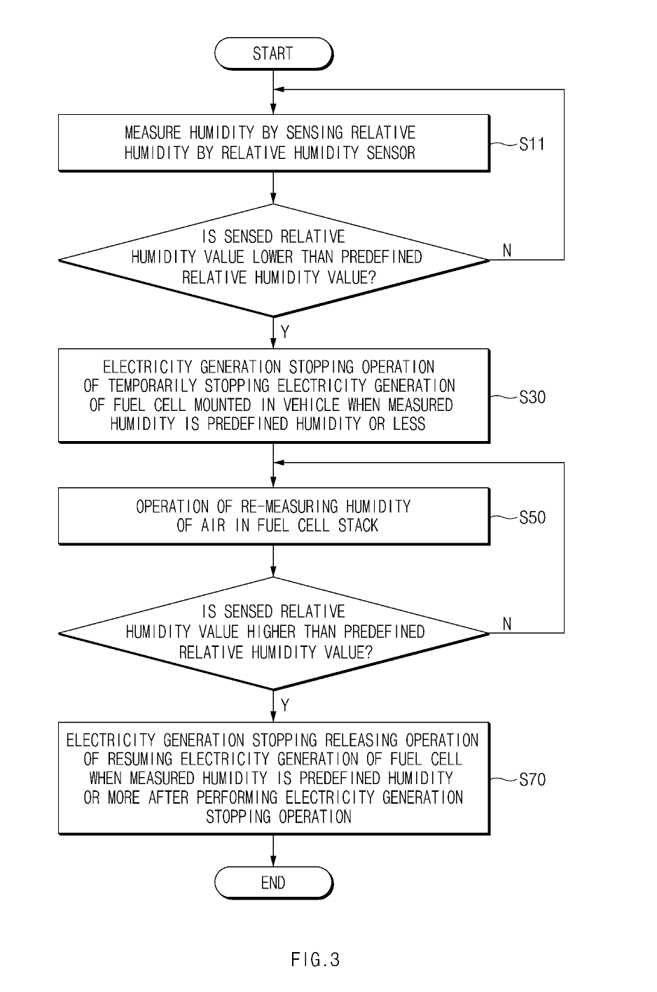

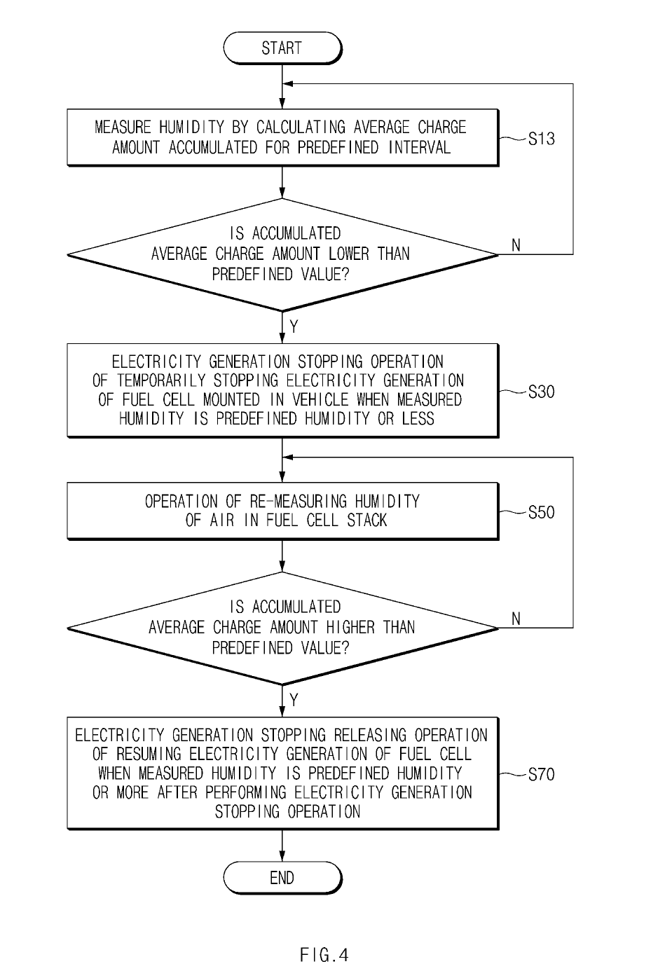

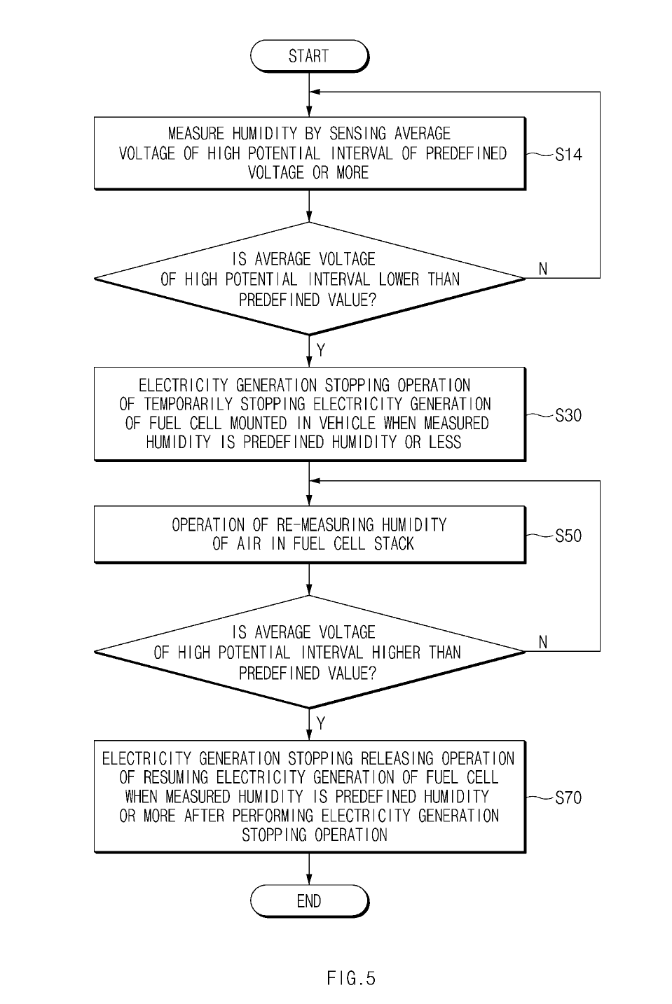

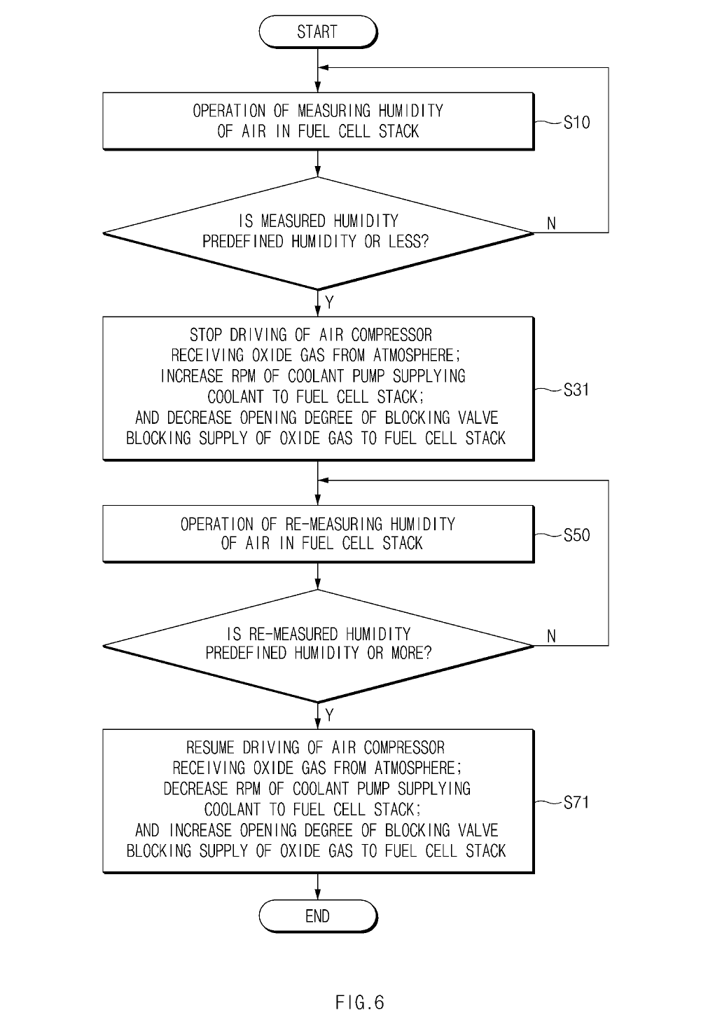

FIGS. 2 to 6 are flowcharts illustrating a control method of a fuel cell system according to an exemplary embodiment of the present disclosure. The control method of the fuel cell system according to an exemplary embodiment of the present disclosure may include measuring humidity of air in a fuel cell stack 20 (S10); and temporarily stopping an electricity generation of a fuel cell mounted within a vehicle when the measured humidity is predefined humidity or less (S30).

The temporary stopping of the electricity generation (S30) may include both an idle stop and a fuel cell (FC) stop. The idle stop refers to stopping the electricity generation of the fuel cell in a signal wait state or a state in which vehicle speed is 0 while the vehicle is being driven. The FC stop refers to a state in which the electricity generation of the fuel cell is temporarily stopped regardless of the vehicle speed.

The controller 60 may be configured to measure the humidity in air, and temporarily stop the electricity generation when the measured humidity is the predefined humidity or less. In the measuring of humidity (S11), a relative humidity sensor 37 may be configured to directly sense relative humidity, and a flowmeter, a pressure gauge, or the like may be disposed in an oxide off gas flow passage 34, thereby making it possible to estimate the relative humidity. The temporary stopping of the electricity generation (S30) may be performed when the sensed relative humidity value is less than a predefined relative humidity value. The controller 60 may be configured to receive information from the relative humidity sensor 37 to determine the relative humidity. When the controller 60 determines that the fuel cell stack 20 is in a dry state, the controller 60 may be configured to temporarily stop the electricity generation (S30).

In the measuring of humidity (S13), the humidity may be measured by calculating an average charge amount accumulated for a predefined interval. when the accumulated average charge amount is low, the controller 60 may be configured to determine that the humidity in the fuel cell stack 20 is low. The temporary stopping of the electricity generation (S30) may be performed when the accumulated average charge amount is less than a predefined value.

In the measuring humidity (S14), an average voltage of a high potential interval of a predefined voltage or greater may be measured. When the average voltage of the high potential interval (e.g., 0.8V or greater) is less than the predefined value, the controller 60 may be configured to determine that the humidity in the fuel cell stack 20 is low. The electricity generation may be temporarily stopped (S31) when the average voltage of the high potential interval is less than the predefined value.

In the temporary stopping of the electricity generation (S31), a driving of the air compressor 32 receiving oxide gas from atmosphere may be stopped. The controller 60 may be configured to stop the driving of the air compressor 32 during the electricity generation stopping operation (S31). Therefore, a discharge amount of moisture may be reduced. In the temporary stopping of the electricity generation (S31), a revolution per minute (RPM) of a coolant pump 81 configured to supply a coolant to the fuel cell stack 20 may be increased. The controller 60 may be configured to increase the RPM of the coolant pump 81 during the stopping of the electricity generation (S31). When the RPM of the coolant pump is increased, a temperature in the fuel cell stack 20 may be decreased and the relative humidity may be increased. As a result, a wet state may be induced. In addition, the discharged amount of moisture may be decreased, and it may be additionally prevented that the relative humidity is decreased.

In addition, in the temporary stopping of the electricity generation (S31), an engagement degree of a blocking value configured to block a supply of oxide gas to the fuel cell stack 20 may be decreased. The controller 60 may be configured to reduce or block a supply of air during the temporary stopping of the electricity generation (S31). Therefore, the discharge amount of moisture may be reduced.

Further, the control method of the fuel cell system according to an exemplary embodiment of the present disclosure may include temporarily stopping an electricity generation of a fuel cell mounted within a vehicle (S30); re-measuring humidity of air in a fuel cell stack 20 after temporarily stopping the electricity generation (S50); and resuming the electricity generation of the fuel cell when the re-measured humidity is predefined humidity or greater (S70).

The control method of the fuel cell system according to an exemplary embodiment of the present disclosure may further include resuming the electricity generation of the fuel cell when the re-measured humidity is the predefined humidity or greater after the temporary stopping of the electricity generation (S70). Since the humidity in the fuel cell stack 20 may be sufficiently high, when the controller 60 determines that the fuel cell stack 20 is in a wet state, the controller 60 may be configured to release the electricity generation stopping operation.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A control method of a fuel cell system, comprising:
measuring, by a controller, humidity of air in a fuel cell stack; and
temporarily stopping, by the controller, an electricity generation of a fuel cell mounted within a vehicle when the measured humidity is predefined humidity or less.

2. The control method according to claim 1, wherein the temporary stopping of the electricity generation is performed when the vehicle is being driven.

3. The control method according to claim 1, wherein the temporary stopping of the electricity generation is performed when the vehicle is stopped.

4. The control method according to claim 1, wherein the temporary stopping of the electricity generation is performed when the measured relative humidity value is less than a predefined relative humidity value.

5. The control method according to claim 4, wherein in the measuring of the humidity, the humidity is measured by calculating an average charge amount accumulated for a predefined interval.

6. The control method according to claim 1, wherein the temporary stopping of the electricity generation is performed when the accumulated average charge amount is less than a predefined value.

7. The control method according to claim 5, wherein in the measuring of the humidity, an average voltage of a high potential interval of a predefined voltage or greater is measured.

8. The control method according to claim 1, wherein the temporary stopping of the electricity generation is performed when the average voltage of the high potential interval is less than a predefined value.

9. The control method according to claim 7, further comprising:
re-measuring, by the controller, the humidity of the air in the fuel cell stack after temporarily stopping the electricity generation; and
resuming, by the controller, the electricity generation of the fuel cell when the re-measured humidity is predefined humidity or greater.

10. The control method according to claim 1, wherein in the temporary stopping of the electricity generation, a driving of an air compressor configured to receive oxide gas from atmosphere is stopped.

11. The control method according to claim 1, wherein in the temporary stopping of the electricity generation, a revolution per minute (RPM) of a coolant pump configured to supply a coolant to the fuel cell stack is increased.

12. The control method according to claim 1, wherein in the temporary stopping of the electricity generation, an opening degree of a blocking valve configured to block a supply of oxide gas to the fuel cell stack is decreased.

13. A control method of a fuel cell system, comprising:
temporarily stopping, by a controller, an electricity generation of a fuel cell mounted within a vehicle;
re-measuring, by the controller, humidity of air in a fuel cell stack after temporarily stopping the electricity generation; and
resuming, by the controller, the electricity generation of the fuel cell when the re-measured humidity is predefined humidity or greater.

14. A control system of a fuel cell assembly, comprising:
a memory configured to store program instructions; and
a processor configured to execute the program instructions, the program instructions when executed configured to:
measure humidity of air in a fuel cell stack; and
temporarily stop an electricity generation of a fuel cell mounted within a vehicle when the measured humidity is predefined humidity or less.

15. The control system of claim 14, wherein the temporary stopping of the electricity generation is performed when the vehicle is being driven.

16. The control system of claim 14, wherein the temporary stopping of the electricity generation is performed when the vehicle is stopped.

17. The control system of claim 14, wherein the temporary stopping of the electricity generation is performed when the measured relative humidity value is less than a predefined relative humidity value.

18. The control system of claim 17, wherein the humidity is measured by calculating an average charge amount accumulated for a predefined interval.

19. The control system of claim 14, wherein the temporary stopping of the electricity generation is performed when the accumulated average charge amount is less than a predefined value.

20. The control system of claim 18, wherein in the measuring of the humidity, an average voltage of a high potential interval of a predefined voltage or greater is measured.
